(19) United States
(12) Patent Application Publication
(10) Pub. No.: US 2012/0091225 A1
(43) Pub. Date: Apr. 19, 2012

(54) EASY-CLEAN SPRAY HEAD FOR A GARDEN HOSE

(75) Inventor: Chin-Yuan Chen, LU-KANG TOWN (TW)

(73) Assignee: SHIN TAI SPURT WATER OF THE GARDEN TOOLS CO., LTD., LU-KANG TOWN (TW)

(21) Appl. No.: 12/907,977

(22) Filed: Oct. 19, 2010

(51) Int. Cl. B05B 15/02

(52) U.S. Cl. 239/106

(57) ABSTRACT

An easy-clean spray head for a garden hose comprises a spray member, an adjustment device and a spray head. The spray member has a hollow body having a water intake channel, a water outlet channel, a pivot portion protruding from a surface of the spray member and attached to a handle, a valve seat disposed in the hollow body having two connecting openings respectively disposed on two sides to respectively fluidly connected to the water intake channel and the water outlet channel, and an outlet head attached onto a front end of the spray member. The adjustment device comprises a knob valve capable of receiving a securing member, a valve cap, a rotatable valve, an elastic member and a valve stem. The spray head comprises a spray member and a cover. The spray member is a flexible material and having a plurality of spray nozzles individually providing a fluidic path.

### BACKGROUND OF THE INVENTION

1. Field of the Invention

The present invention relates to a garden hose, and more particularly to an easy-clean spray head for a garden hose which has a flexible spray member that can be cleaned by hand to remove dirt or sand in the spray nozzle.

2. Description of the Related Art

Currently, spray heads for typical garden hoses are often covered with dirt or sand due to their working environment, such that the flow of water may become clogged. Therefore, such spray heads generally require scrubbing tools for cleaning, which leads to additional expenses. Furthermore, the spray holes for the spray head are usually designed as fine apertures, which can be very difficult to clean.

Therefore, it is desirable to provide an easy-to-clean spray head for a garden hose to mitigate and/or obviate the aforementioned problems.

### SUMMARY OF THE INVENTION

An objective of the present invention is to provide an easy-to-clean spray head for a garden hose.

In order to achieve the above-mentioned objectives, an easy-clean spray head for a garden hose comprises a spray member, an adjustment device and a spray head. The spray member has a hollow body having a water intake channel, a water outlet channel, a pivot portion protruding from a surface of the spray member and attached to a handle, a valve seat disposed in the hollow body having two connecting openings respectively disposed on two sides to respectively fluidly connected to the water intake channel and the water outlet channel, and an outlet head attached onto a front end of the spray member. The adjustment device comprises a knob valve capable of receiving a securing member, a valve cap, a rotatable valve, an elastic member and a valve stem. The spray head comprises a spray member and a cover. The spray member is a flexible material and having a plurality of spray nozzles individually providing a fluidic path.

With the above-mentioned structure, the following benefits can be obtained: when the fluidic path of the spray member of the spray head is clogged by dirt or sand, since the spray member is a flexible material and the plurality of spray nozzles are made as a single unit, dirt or sand clogging the fluidic path can be removed by hand. Additionally, the spray head can also provide hand cleaning and message functions.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment of the present invention.

FIG. 2 is a perspective exploded view of an embodiment of the present invention.

FIG. 3 is a detailed drawing of a rotatable valve of an embodiment of the present invention.

FIG. 4 is a cross-sectional view of an embodiment of the present invention.

FIG. 5 is another cross-sectional view when water is flowing through according to an embodiment of the present invention.

FIG. 6 is a local cross-sectional view showing spray nozzles clogged by sand or dirt.

FIG. 7 is a schematic drawing of the spray head being cleaned by hand.

### DETAILED DESCRIPTION OF THE PREFERRED EMBODIMENT

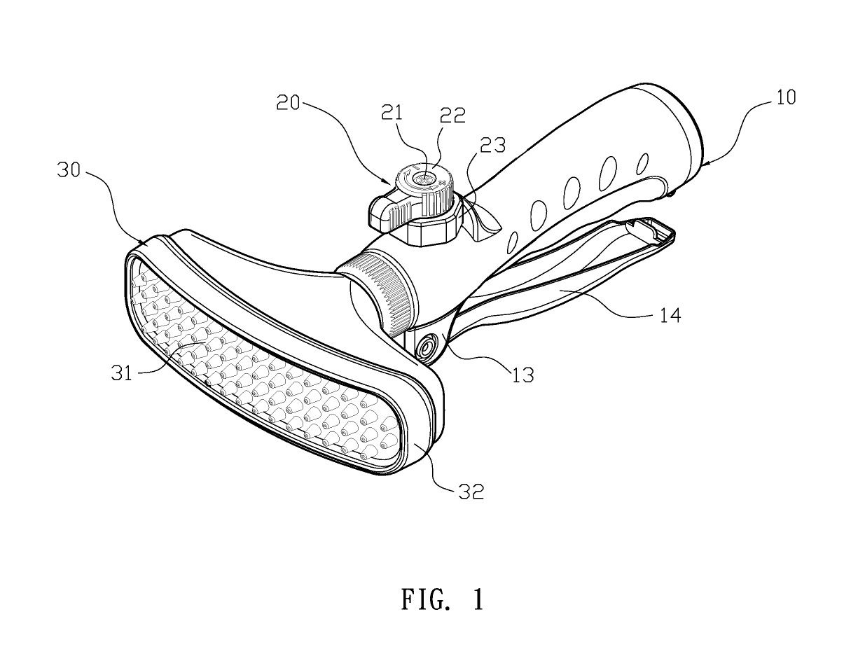

First please refer to FIG. 1 to FIG. 4. An easy-clean spray head for a garden hose comprises a spray member 10, an adjustment device 20 and a spray head 30. The spray member 10 is a hollow body and has a water intake channel 11, a water outlet channel 12, a pivot portion protruding from a surface of the spray member 10 and attached to a handle 14 via a screw. A valve seat 15 is disposed in the hollow body and has two connecting openings respectively disposed on two sides to be respectively fluidly connected to the water intake channel 11 and the water outlet channel 12. The two connecting openings are disposed at different height levels and form a fluidic channel 151, and the fluidic channel 151 has a stopping edge 152 at a bottom edge thereof and extends upward to form an engaging section 16. An outlet head 17 is attached onto a front end of the spray member 10. The adjustment device 20 comprises a knob valve 22 capable of receiving a securing member 21, a valve cap 23, a rotatable valve 24, an elastic member 25 and a valve stem 26. The valve cap 23 has an engaging slot 231 at a bottom side. The rotatable valve 24 is a casing and has an internal connecting opening 241, a securing aperture 242 formed in a top surface, and an intake openings 243 formed at a bottom edge. The valve stem 26 has an O-ring 261 disposed around a top end and an extended portion 262 formed at another end. The spray head 30 comprises a spray member 31 and a cover 32. The spray member 31 is a flexible material such as silicon and has a plurality of spray nozzles 311 individually providing a fluidic path 312 formed as a single unit and protruding from one side. The cover 32 has a plurality of through apertures 321 corresponding to the spray nozzles 311 and an engaging rim 322 along an outer edge. Moreover, the diameter of the through aperture 321 of the cover 32 is smaller than the diameter of the spray nozzle 311.

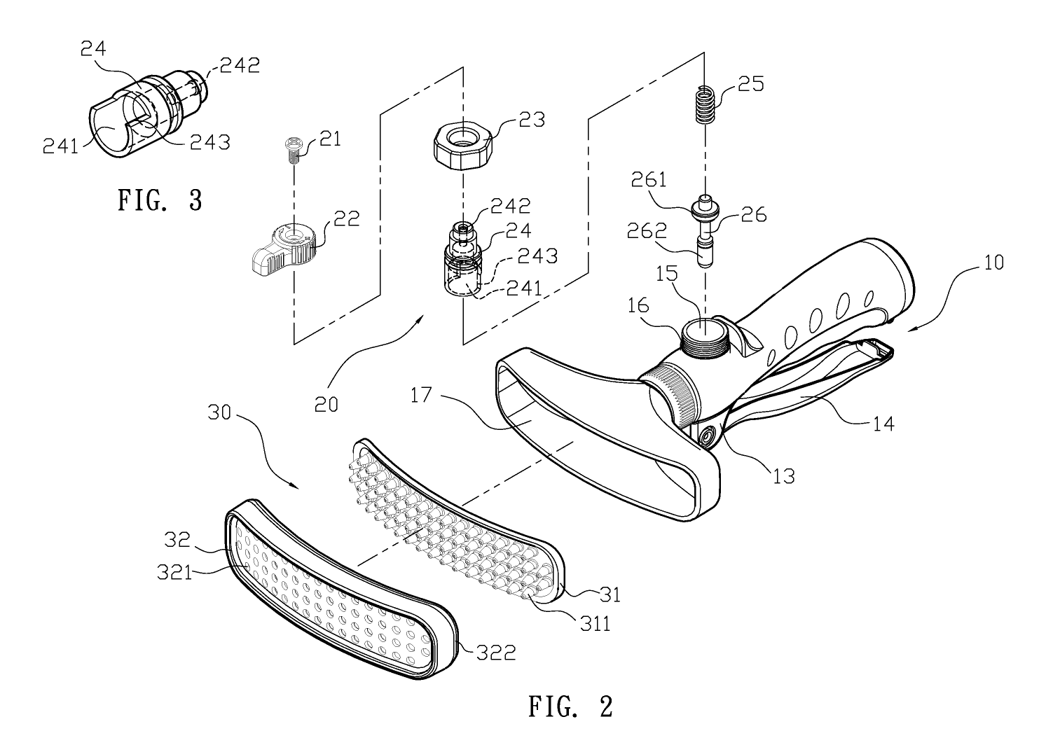

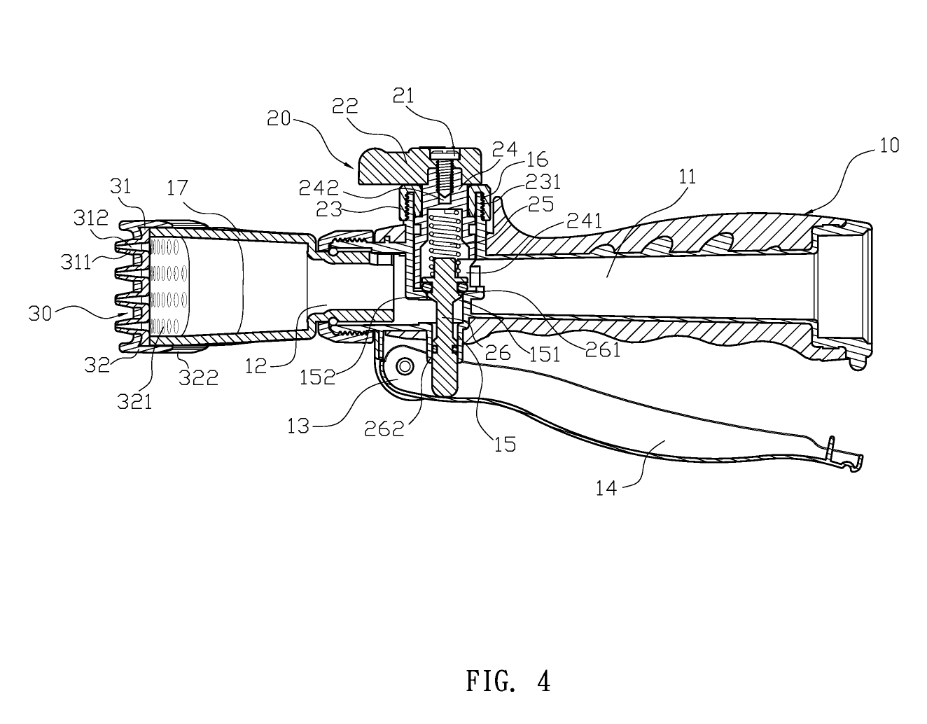

For assembly process, please refer to FIG. 2 with FIG. 4. The extended portion 262 of the valve stem 26 is disposed in the valve seat 15 of the spray member 10 and engages with the handle 14 at one end. The elastic member 25 and the rotatable valve 24 are disposed in the valve seat 15 and jacketed onto the top end of the valve stem 26, and the valve cap 23 is screwed onto the engaging section 16 of the spray member 10. Then the securing member 21 is placed through the knob valve 22 and secured onto the securing aperture 242 of the rotatable valve 24 such that the knob valve 22 is capable of rotating simultaneously with the rotatable valve 24 to complete the adjustment device. The spray nozzles 311 of the spray member 31 are placed through the through apertures 321 of the cover 32, and the engaging rim 322 of the cover 32 is disposed to cover the outlet head 17 of the spray member 10.

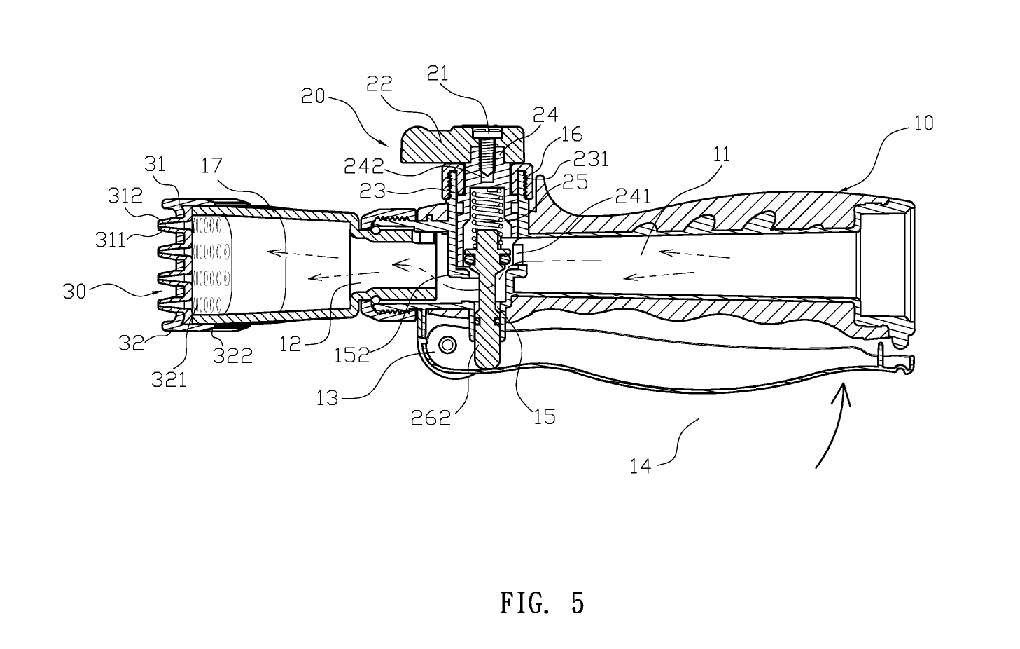

For actual operations, please refer to FIG. 5 together with FIG. 2.

When the garden hose is not been used, the valve stem 26 is pushed down by the elastic member 25 to open the handle 14, and the O-ring 261 is disposed in the channel 151 of the valve seat 15 of the spray member 10 and pushes against to the stopping edge 152 such that the water intake channel 11 and the water outlet channel 12 are fluidly isolated by the O-ring 261 of the valve stem 26. When the handle 14 is pressed up to push up the valve stem 26 and compresses the elastic member 25, the O-ring 261 of the valve stem 26 is lifted up such that the water intake channel 11 and the water outlet channel 12 of the spray member 10 are fluidly connected together. Therefore, water is able to flow into the water intake channel 11, passes through the intake opening 243 and the connecting opening 241 of the rotatable valve 24, then flows through the channel 151 and the water outlet channel 12 to exit from the fluidic path 312 of the spray member 31 of the spray head 30. As shown in FIG. 4, in order to adjust the water discharge amount, the knob valve 22 is rotated to simultaneously rotate the rotatable valve 24 such that the size of intake opening 243 is changed for different water output amounts.

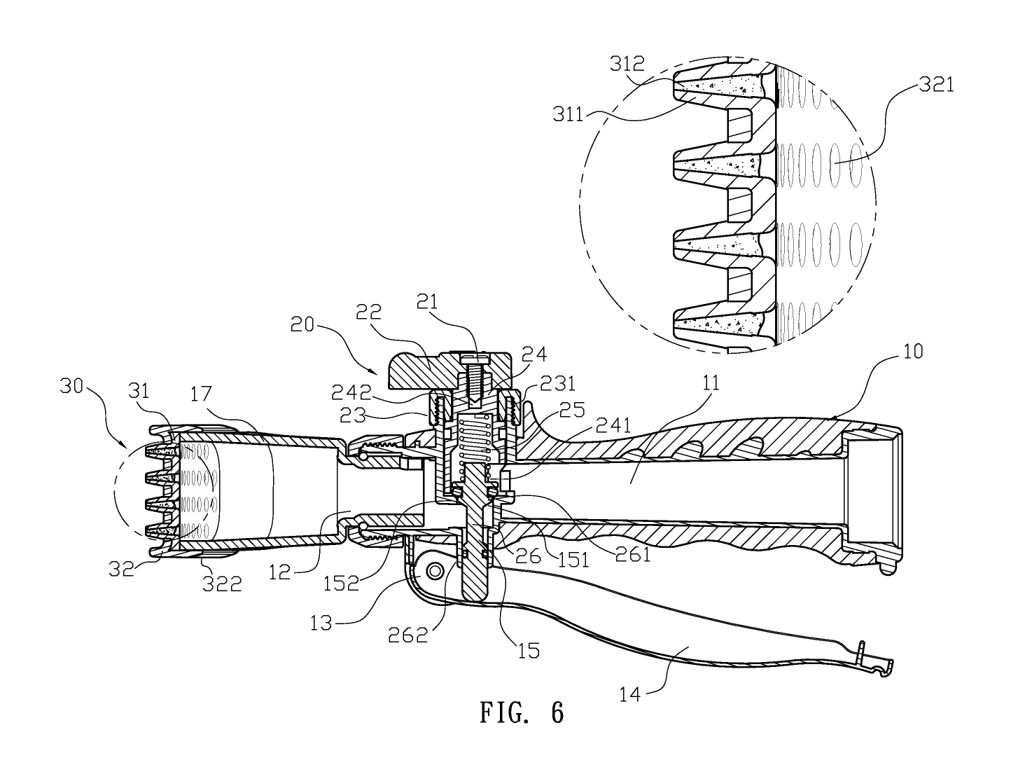

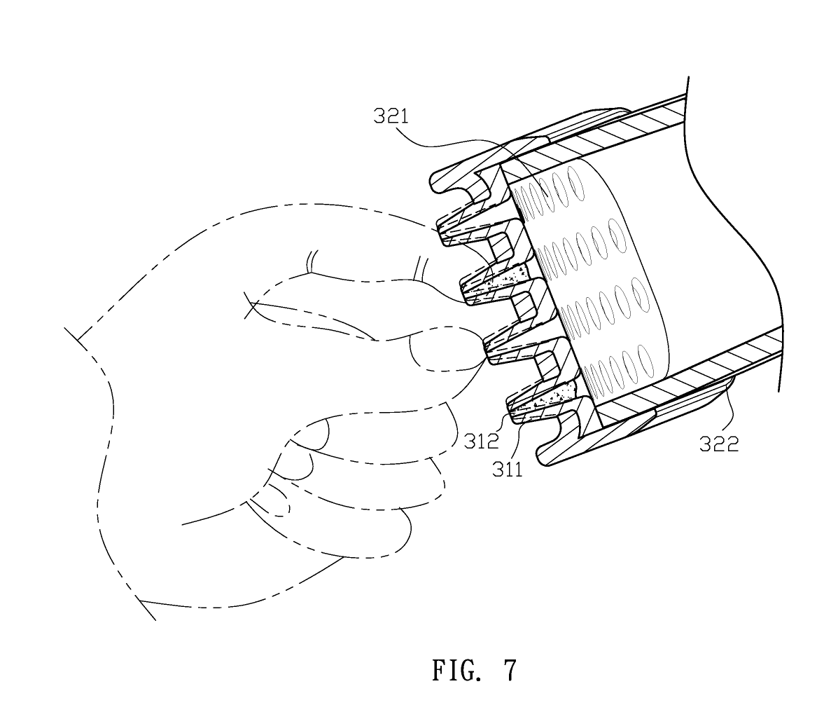

For usage please refer to FIG. 6 and FIG. 7. When the fluidic path 312 of the spray member 31 of the spray head 30 is clogged by dirt or sand, since the spray member 31 is a flexible material and the plurality of spray nozzles 311 are made as a single unit, the dirt or sand clogging the fluidic path 312 can be removed with fingers. Moreover, the spray head 30 can also provide hand cleaning and message functions.

With the above-mentioned structure, the following benefits can be obtained: when the fluidic path 312 of the spray member 31 of the spray head 30 is clogged by dirt or sand, since the spray member 31 is a flexible material and the plurality of spray nozzles 311 are made as a single unit, dirt or sand clogging the fluidic path 312 can be removed by hand. Additionally, the spray head 30 can also provide hand cleaning and message functions.

Although the present invention has been explained in relation to its preferred embodiment, it is to be understood that many other possible modifications and variations can be made without departing from the spirit and scope of the invention as hereinafter claimed.

What is claimed is:

1. An easy-clean spray head for a garden hose comprising a spray member, an adjustment device and a spray head; wherein
the spray member has a hollow body having a water intake channel, a water outlet channel, a pivot portion protruding from a surface of the spray member and attached to a handle via a screw, a valve seat disposed in the hollow body having two connecting openings respectively disposed on two sides to respectively fluidly connected to the water intake channel and the water outlet channel, the two connecting openings disposed at different height levels and forming a fluidic channel, the fluidic channel having a stopping edge at a bottom edge and extending upward to form an engaging section, and an outlet head is attached onto a front end of the spray member;
the adjustment device comprises a knob valve capable of receiving a securing member, a valve cap, a rotatable valve, an elastic member and a valve stem, the valve cap having an engaging slot at a bottom side; the rotatable valve being a casing having an internal connecting opening, a securing aperture formed in a top surface, and an intake openings formed at a bottom edge; the valve stem having an O-ring disposed around a top end and an extended portion formed at another end;
the spray head comprises a spray member and a cover; the spray member being a flexible material and having a plurality of spray nozzles individually providing a fluidic path formed as one unit and protruding from one side; the cover having a plurality of through apertures corresponding to the spray nozzles and an engaging rim along an outer edge;
wherein the extended portion of the valve stem is disposed in the valve seat of the spray member and engages with the handle at one end; the elastic member and the rotatable valve are disposed in the valve seat and jacketed onto the top end of the valve stem, the valve cap screwed onto the engaging section of the spray member, the securing member placed through the knob and secured onto the securing aperture of the rotatable valve such that the knob is valve capable of rotating simultaneously with the rotatable valve to complete the adjustment device; the spray nozzles of the spray member are placed through the through aperture of the cover, and the engaging rim of the cover is disposed to cover the outlet head of the spray member.

2. The easy-clean spray head as claimed in claim 1, wherein the spray member is made of a silicon material.

3. The easy-clean spray head as claimed in claim 1, wherein the diameter of the through aperture of the cover is smaller than the diameter of the spray nozzle.
